(19) United States
(12) Patent Application Publication
(10) Pub. No.: US 2014/0012743 A1
(43) Pub. Date: Jan. 9, 2014

(54) CALENDAR BILL PAYMENT MANAGEMENT

(71) Applicants: Carrie Anne Hanson, Charlotte, NC (US); Scott R. Enscoe, Charlotte, NC (US); Alexander C. Wittkowski, Charlotte, NC (US); Laura Corinne Bondensen, Charlotte, NC (US); Leland E. Modesitt, III, Charlotte, NC (US); David M. Grigg, Rock Hill, SC (US); Daniel David, Charlotte, NC (US); Katherine Dintenfass, Charlotte, NC (US); Ray R. Hernandez, Austin, TX (US); Brett Newman, Burlingame, CA (US); Leo Kopelow, San Francisco, CA (US); Yameng Li, Berkeley, CA (US); Nicole Chen, San Francisco, CA (US); Nicholas Sharp, San Francisco, CA (US)

(72) Inventors: Carrie Anne Hanson, Charlotte, NC (US); Scott R. Enscoe, Charlotte, NC (US); Alexander C. Wittkowski, Charlotte, NC (US); Laura Corinne Bondensen, Charlotte, NC (US); Leland E. Modesitt, III, Charlotte, NC (US); David M. Grigg, Rock Hill, SC (US); Daniel David, Charlotte, NC (US); Katherine Dintenfass, Charlotte, NC (US); Ray R. Hernandez, Austin, TX (US); Brett Newman, Burlingame, CA (US); Leo Kopelow, San Francisco, CA (US); Yameng Li, Berkeley, CA (US); Nicole Chen, San Francisco, CA (US); Nicholas Sharp, San Francisco, CA (US)

(73) Assignee: BANK OF AMERICA CORPORATION, Charlotte, NC (US)

(21) Appl. No.: 13/543,649

(22) Filed: Jul. 6, 2012

(51) Int. Cl. G06Q 40/00

(52) U.S. Cl. 705/40; 705/35; 705/42; 705/44

(57) ABSTRACT

Embodiments of the invention are directed to systems, computer-implemented methods, and computer program products for providing, via a mobile device associated with a user, a calendar for displaying one or more financial events including the steps of accessing a storage device associated with the mobile device to thereby retrieve information associated with the calendar and information associated with the one or more financial events, presenting, via a display of the mobile device, the calendar with the one or more financial events provided therein, wherein each of the one or more financial events is selectable by the user, providing, via each of the one or more financial events, one or more selectable features configured to allow the user to take an action relating to the one or more financial events.

### FIELD

In general, embodiments of the invention relate to systems, methods, and computer program products for providing financial events via a mobile calendar.

### BACKGROUND

Typically, individuals depend on their mobile devices to keep up with the events of their everyday lives and presently, rely on their mobile devices to accomplish a significant variety of tasks. Some individuals use their mobile devices for everyday tasks, other than making phone calls, including, gaming, web browsing, social networking, shopping, etc. The above-mentioned activities are just a few examples to show that individuals continue to find non-traditional uses for their mobile devices.

Although mobile devices now have numerous features and applications that allow individuals to complete a range of tasks and/or to simply occupy their time, it is becoming more apparent that some individuals are seeking functions, features, or applications that better enable the integration of some of the most important aspects of their lives with their mobile devices.

Therefore, a need exists for a way to provide a mobile calendar that allows an individual to manage social and financial events on a mobile device.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is present later.

Embodiments of the invention are directed to systems, methods, and computer program products for providing, via a mobile device associated with a user, a calendar for displaying one or more financial events. In one embodiment, the invention comprises: (1) a mobile device for providing a secure calendar for presenting one or more financial events, the mobile device comprising a communication interface, a processing device, and a display, (2) a storage device associated with the mobile device, the storage device comprising information associated with a calendar and information associated with one or more financial events, and (3) a non-transitory computer-readable medium comprising computer-executable instruction code, that when executed causes the processing device to: (a) access the storage device associated with the mobile device to thereby retrieve information associated with the calendar and information associated with one or more financial events, (b) present, via the display of the mobile device, the calendar with the one or more financial events provided therein, wherein each of the one or more financial events is selectable by the user, (c) provide security for contents of the calendar, and (d) provide, via each of the one or more financial events, one or more selectable features configured to allow the user to take an action relating to the one or more financial events.

In one embodiment of the invention, the one or more financial events are one or more upcoming bills associated with the user.

In another embodiment of the invention, the system receives, from the user, via the calendar a selection of the one or more selectable features and redirects the user to an online banking website based at least partially on receiving the selection.

In yet another embodiment of the invention, the system receives, via the calendar, one or more manual inputs of one or more projected financial events associated with the user, wherein the one or more manual inputs of the one or more projected financial events relate at least partially to one or more upcoming expenses or one or more upcoming bills.

In one embodiment, the system triggers an update of a projected money flow outlook for the user based at least partially on receiving the one or more manual inputs of one or more projected financial events. The system further updates the projected money flow outlook based at least partially on the one or more manual inputs and presents via the calendar the projected money flow outlook updated with the one or more manual inputs of the one or more projected financial events.

In a further embodiment of the invention, the system provides a user interface configured to receive an indication that the user would like to receive, at the mobile device, a feed of one or more financial events from a server associated with a financial institution associated with the user. The system is further configured to receive the indication from the user.

In yet a further embodiment of the invention, the system presents, via the mobile device, a user-authentication screen to the user for accessing the contents of the calendar, wherein the user-authentication screen is configured to receive one or more inputs from the user.

In one embodiment of the invention, the system receives one or more updates from a server associated with a financial institution, wherein the one or more updates relate at least partially to one or more financial events associated with an online bill payment system or electronic bill system.

In another embodiment of the invention, a computer program product is provided for providing, via a mobile device associated with a user, a calendar for displaying one or more financial events. In one embodiment, the computer program product comprises: a non-transitory computer readable medium comprising a set of codes for causing a computer to: (a) access the storage device associated with the mobile device to thereby retrieve information associated with the calendar and information associated with one or more financial events, (b) present, via the display of the mobile device, the calendar with the one or more financial events provided therein, wherein each of the one or more financial events is selectable by the user, (c) provide security for contents of the calendar, and (d) provide, via each of the one or more financial events, one or more selectable features configured to allow the user to take an action relating to the one or more financial events.

In one embodiment of the invention, the computer program product uses a set of codes to receive, from the user, via the calendar a selection of the one or more selectable features and redirects the user to an online banking website based at least partially on receiving the selection.

In one embodiment of the invention, the computer program product uses a set of codes to receive, via the calendar, one or more manual inputs of one or more projected financial events associated with the user, wherein the one or more manual inputs of the one or more projected financial events relate at least partially to one or more upcoming expenses or one or more upcoming bills.

In one embodiment of the invention, the computer program product uses a set of codes to: (a) trigger an update of a projected money flow outlook for the user based at least partially on receiving the one or more manual inputs of one or more projected financial events, (b) update the projected money flow outlook based at least partially on the one or more manual inputs, and (c) present via the calendar the projected money flow outlook updated with the one or more manual inputs of the one or more projected financial events.

In one embodiment of the invention, the computer program product uses a set of codes to present, via the mobile device, a user-authentication screen to the user for accessing the contents of the calendar, wherein the user-authentication screen is configured to receive one or more inputs from the user.

As another example, in another embodiment of the invention, a computer-implemented method is provided for providing, via a mobile device associated with a user, a calendar for displaying one or more financial events. In one embodiment, the computer-implemented method comprises: providing a computer processor executing computer readable code structured to cause the computer processor to: (a) access a storage device associated with the mobile device to thereby retrieve information associated with the calendar and information associated with one or more financial events, (b) present, via a display of the mobile device, the calendar with the one or more financial events provided therein, wherein each of the one or more financial events is selectable by the user, (c) provide security for contents of the calendar, and (d) provide, via each of the one or more financial events, one or more selectable features configured to allow the user to take an action relating to the one or more financial events.

In one embodiment of the computer-implemented method, the method receives, from the user, via the calendar a selection of the one or more selectable features and redirects the user to an online banking website based at least partially on receiving the selection.

In another embodiment of the computer-implemented method, the method receives, via the calendar, one or more manual inputs of one or more projected financial events associated with the user, wherein the one or more manual inputs of the one or more projected financial events relate at least partially to one or more upcoming expenses or one or more upcoming bills.

In one embodiment of the computer-implemented method, the method (a) triggers an update of a projected money flow outlook for the user based at least partially on receiving the one or more manual inputs of one or more projected financial events, (b) updates the projected money flow outlook based at least partially on the one or more manual inputs, and (c) presents via the calendar the projected money flow outlook updated with the one or more manual inputs of the one or more projected financial events.

In one embodiment of the computer-implemented method, the method presents, via the mobile device, a user-authentication screen to the user for accessing the contents of the calendar, wherein the user-authentication screen is configured to receive one or more inputs from the user.

In one embodiment of the computer-implemented method, the method provides a user interface configured to receive an indication that the user would like to receive, at the mobile device, a feed of one or more financial events from a server associated with a financial institution associated with the user. The method further receives the indication from the user.

In one embodiment of the computer-implemented method, the calendar is a combination of, at least two calendars, the calendar comprising a first calendar associated with the mobile device associated with the user and a second calendar accessible via an online banking account associated with the user, wherein the first calendar comprises one or more non-financial related events, and wherein the second calendar comprises one or more financial related events.

### BRIEF DESCRIPTION OF THE DRAWINGS

Having thus described embodiments of the invention in general terms, reference will now be made to the accompanying drawings, where

FIG. 1 is flowchart illustrating a general process flow for providing a secure calendar for displaying one or more financial events, in accordance with embodiments of the invention.

FIG. 2 is a block diagram of an example system for providing a calendar, in accordance with embodiments of the invention.

FIG. 3 is a block diagram of a mobile device associated with the user for providing a calendar, in accordance with embodiments of the invention.

FIG. 4A is an example of a graphical user interface for a calendar for bill payment management in accordance with some embodiments of the invention.

FIG. 4B is an example of a graphical user interface for adding financial events to a calendar in accordance with some embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa unless explicitly stated otherwise. Also, as used herein, the term “a” and/or “an” shall mean “one or more,” even though the phrase “one or more” is also used herein. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

As will be appreciated by one of ordinary skill in the art in view of this disclosure, the invention may be embodied as an apparatus (including, for example, a system, machine, device, computer program product, or any other apparatus), method (including, for example, a business process, computer-implemented process, or any other process), a system, a computer program product, and/or any combination of the foregoing. Accordingly, embodiments of the invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the invention may take the form of a computer program product having a computer-readable storage medium having computer-executable program code embodied in the medium.

Reference in this specification to “one embodiment” or “an embodiment” means that a particular feature, structure, or characteristic described in connection with the embodiments is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Any suitable computer-readable medium may be utilized. The computer-readable medium may be, for example but not limited to, an electronic, magnetic, optical, electromagnetic, infrared, or semiconductor system, apparatus, or device. For example, in one embodiment, the computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or other tangible optical or magnetic storage device.

Computer-executable program code for carrying out operations of the invention may be written in object oriented, scripted and/or unscripted programming languages such as Java, Perl, Smalltalk, C++, SAS, SQL, or the like. However, the computer-executable program code portions for carrying out operations of the invention may also be written in conventional procedural programming languages, such as the “C” programming language or similar programming languages.

Some embodiments of the invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The computer-executable program code may also be loaded onto a computer or other programmable data processing apparatus to cause a series of operational steps to be performed on the computer or other programmable apparatus to produce a computer-implemented process such that the computer-executable program code which executes on the computer or other programmable apparatus provides steps for implementing the functions/acts specified in the flowchart and/or block diagram block(s). Alternatively, computer-implemented steps or acts may be combined with operator or human implemented steps or acts in order to carry out an embodiment of the invention.

In some embodiments, the “user” may be a consumer or a customer (e.g., an account holder or a person who has an account (e.g., banking account, credit account, etc.) at the entity) or potential customer (e.g., a person who has submitted an application an account).

The term “consumer,” as described in many of the embodiments herein, refers to any person, association, machine, apparatus, and/or anything capable of buying, using, consuming, and/or acquiring one or more products from a business merchant. In some embodiments, a consumer may be a business merchant and/or vice versa. In other embodiments, a consumer may be a customer of a bank or some other financial institution.

For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the financial institution may allow a user to establish an account with the financial institution. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, etc. The account is associated with and/or maintained by the financial institution.

The term “financial event(s),” as used herein in many of the embodiments, may refer to any activity, action, transaction, reminder, alert, trigger, group of triggers, group of events, group of actions, group of activities, and/or group of transactions relating to and/or is of a financial nature. In various embodiments, a financial event may include non-recurring and/or recurring bills, expenses, payments, expected payments, receivables, liabilities, allowances, and/or the like. In some embodiments, a financial event may also refer to financial transactions including closing on a mortgage and/or a loan, expected inflows of money and/or credits, executing financial documents, reviewing and/or confirming financial documents, preparation of financial documents, trading stock and/or other equities, investment transactions, etc. A “bill,” as referred to herein, may be a statement or itemized list of charges owed to a merchant, an individual, or some other entity. A financial event may also include the details of the event including the parties to the event, such as the biller and/or billee, date and/or time of the event, place and/or location for the event, actions to be taken and/or completed for the event, etc. A financial event may encompass a variety of events related to personal and/or non-personal finances and various events that are monetary in nature and/or related to finance, as such, the previously-mentioned examples and embodiments are not intended to limit the definition of a financial event.

In general terms, embodiments of the invention are directed to systems, methods, and computer program products for providing, via a mobile device, a calendar for displaying and/or managing one or more financial events. In one embodiment, the invention relates to a calendar providing access to one or more financial events and/or one or more life events of a user. The one or more financial events may include all the expect cash flows associated with the user, which include cash outflows for expect bill payments and inflows for expected credits or payments to the user. In an embodiment, the calendar displays a user's financial events in the days, weeks, months, or years in which those events occur, or when the events are scheduled to occur. A user may enroll or opt-in to a feed from a financial institution associated with the user and, using the information associated with the feed, the calendar is automatically populated and/or updated with the user's future, present, and/or past financial events. Accordingly, the calendar that is accessible via the user's mobile device provides the user's life events and access to financial events of the user, so that the user may access those financial events via the calendar and act upon them (e.g., pay an upcoming bill, pay a bill that is due, execute a loan document, provide account information for receiving funds, and/or the like).

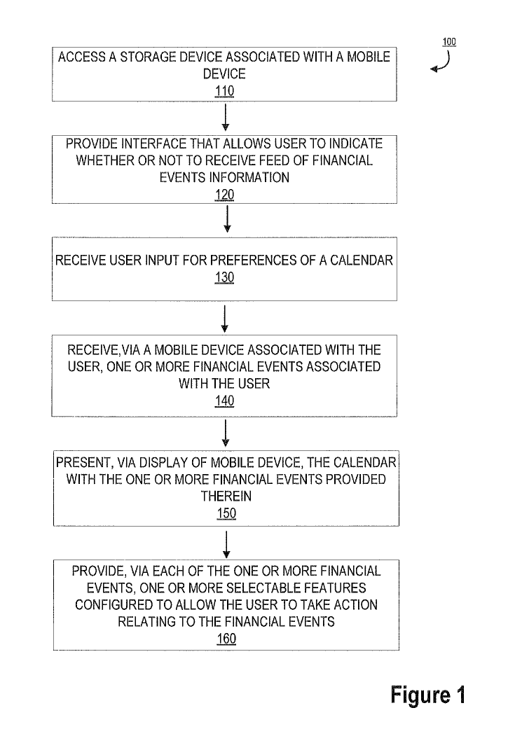

FIG. 1 illustrates a general process flow 100 for providing, a calendar, in accordance with an embodiment of the invention. As represented by block 110, the system accesses the storage device associated with the mobile device to thereby retrieve information associated with the calendar and information associated with the one or more financial events. In some embodiments, the storage device associated with the mobile device is a memory device located within the mobile device. In one embodiment, the storage device associated with the mobile device is a database for storing information associated with an online banking account associated with the user, where the database is maintained by a financial institution. In yet another embodiment, the storage device associated with the mobile device is a remote database for storing and maintaining information associated with the calendar maintained by a third party.

In one embodiment, the calendar is a personal calendar associated with the user. In such cases, the information associated with the calendar may include scheduled events and functions not related to financial events. As such, the calendar may relate to social or other business aspects of the user's scheduled activities. In one embodiment, the calendar is accessible only via a mobile device associated with the user. In some embodiments, the calendar is accessible via a personal computer with the user. In other embodiments, the calendar is accessible by the user via an online banking/financial account associated with the user. In some embodiments, the calendar is provided by a financial institution associated with the user.

In some embodiments, the information associated with the one or more financial events may include various details including parties to a financial event, date and/or time, actions to be taken, payment amounts due, and/or a scheduled activity relating to the one or more financial events. For example, in one embodiment, the information associated with a financial event may include the name of a biller for past services rendered, payment amounts, and due date for the payment amounts.

In some embodiments, the calendar is a combination of, at least, two or more electronic calendars. In such instances, the calendar may comprise a first calendar and a second calendar. The first calendar comprises non-financial events associated with the user. The second calendar may be associated with an online financial account that includes one or more financial events. The user, in some embodiments, may choose which events of the first calendar and the second calendar to combine.

As represented by the block 120, the system provides an interface that allows the user to indicate whether the user would like to receive a feed of financial events onto a calendar. In some embodiments, the user indicates that he/she would like to receive a feed of financial events by opting-in to a feed service associated with a financial institution associated with the user. In other embodiments, the user may enroll into a feed service that provides financial events to a calendar associated with the user. The indication may be verbal (e.g., in person) or non-verbal (e.g., via an online banking system). This indication is received in person, over the phone, via computer system, via an email or an online form transmitted over a network (e.g., an online banking system), through the postal system, or in any other manner. For example, in one embodiment, the user is a current customer of the financial institution such that the financial institution has financial events data, financial transaction data, and/or other data associated with the customer.

In one embodiment, the information from the feed is associated with an online bill payment system associated with the user. In such instances, the feed provides to the user's mobile device and/or other computer device information regarding one or more recurring and/or non-recurring presently due and/or upcoming bill payments. In another embodiment, the feed is associated with a calendar accessible via an online banking/financial account associated with the user. In this instance, the calendar accessible via the online banking account is a calendar populated with one or more financial events associated with the user.

As represented by the block 130, the system receives input for preferences of the user and/or settings for the calendar. These preferences and/or settings relate to management of the calendar; for example, preferences and/or settings regulate various operations of creating, managing and presenting the one or more financial events via the calendar, such as the types of data and bill details to include in the financial events, type of security features for the calendar, when to alert regarding financial events according to various triggering events, or any other preferences and/or settings appropriate to the calendar. Many different types of preferences and/or settings are also possible and the invention should not be limited to the above-recited user preference options. In one embodiment, all of the preferences of the user and/or settings are received by the system during an enrollment/opting-in into the feed service of financial events from the financial institution associated with the user. In one embodiment the system receives input preferences from a mobile device associated with the user. In another embodiment, the system receives input preferences from a personal computer or computing device accessible to the user.

In one embodiment, the system provides security for the contents of the calendar. In some embodiments, the user may select the type of security he/she would like provided for the calendar. The types of security may include various authentication-based security including username/password feature, biometrics-based authentication, challenge-based security, encryption-based security for updates and transmissions from a feed and transmissions to a financial institutions server, etc. For example, in one embodiment, the user may input as a preference that he/she would like username/password authentication and thus, the system would guide the user through a username/password setup and subsequently present a username/password prompt before the user or any other person can access the calendar.

In one embodiment, the user may provide as a preference and/or setting of the calendar access to a second user and/or other users. In such an embodiment, the user and/or the second user may set up a separate authentication for accessing the contents of the calendar that is distinct or different from the authentication of the user for accessing the calendar. For example, the user may wish to provide her spouse access to the financial events on her calendar by providing a separate password and login for her spouse so that her spouse can access the user's calendar via a different mobile device associated with the spouse. In some embodiments, the user may link a second user's calendar to her calendar, wherein by linking the calendars the financial events and/or other information can be shared between the two calendars. In another embodiment, the user can provide access to a second user by linking the second user's online banking account to an online banking account associated with the calendar.

As represented by the block 140, the system having the process flow 100 also receives, via a mobile device associated with the user, one or more financial events associated with the user to thereby populate and/or update the calendar. In one embodiment, the one or more financial events received via the mobile device are stored in a storage device associated with the mobile device. In one embodiment, the one or more financial events, received via the mobile device, relate at least in part to one or more financial and non-financial accounts to which the user makes recurring and/or non-recurring payments. In some embodiments, the one or more financial events relate at least in part to one or more financial documents that require review and/or execution by the user. For example, the mobile device may gather and/or receive financial events data from an online banking account associated with the user. In such instances, the user employs an online bill payment system having data and other information relating to the due dates, payment preferences, and payment frequencies of various bills associated with the user. The system will receive the various due dates, payment preferences, and payment frequencies associated with the bills and store them onto a storage device associated with the mobile device.

Additionally in block 140, in some embodiments, the system is configured to receive from the user one or more manual entries of one or more projected financial events associated with the user. In one embodiment, the system is configured to receive one or more manual entries of projected financial events, via an online banking account associated with the user. In such instances, the user may access a calendar via the online banking account and using one or more input devices (e.g., mouse, keyboard, touch screen, etc.) the user enters one or more present and/or future projected financial events into the calendar. In some embodiments, the calendar accessible via the online banking account interface communicates with the user's mobile device to update the calendar accessible to the user via the user's mobile device. In some embodiments, the system is configured to receive manual entries of one or more projected financial events from the user. As an example, the user may expect one or more in flows of money and/or credits at a future date and/or time, and so the user may manually enter the expected inflow of money into the calendar as a financial event. In one embodiment, the user's mobile device comprises a graphical user interface that allows the user to access the calendar. In such instances, the user may access the calendar and using various input devices (touch screen, keyboard, voice command, etc.) associated with the mobile device the user may enter one or more recurring or non-recurring present and/or future financial events into the calendar.

In one embodiment, the system is configured to trigger an update of a projected money flow outlook for the user based at least partially on receiving the one or more manual entries of one or more projected financial events associated with the user. The system will then update the projected money flow outlook based at least in part on the one or more manual entries. Next the system will present, via the calendar, the projected money flow outlook updated with the one or more manual entries of the one or more projected financial events. A “money flow outlook,” as used herein, refers to an illustration of an estimation and/or forecast of future inflows and outflows of money and/or credit totals of various financial events that is based at least in part on the financial events associated with the user's calendar. In some embodiments, the money flow outlook includes various aggregates and totals for different types of financial events. In some embodiments, some financial event types may include credit card bills, utility bills, food expenses, housing expenses, travel expenses, repayment to the user of loaned funds, refunds and/or credits expect by the user, and/or the like. In one embodiment, the money flow outlook may be presented in the form of a bar graph, a line graph, a scatter plot, or any other graph or tool that can be used to represent illustrate in a user interface various payments and/or liabilities that will be due in the future on various bills or expenses associated with the user.

Also in block 140, in some embodiments, the system may be configured to receive user data relating to user-specific events. User-specific events may include any event in which the user is a direct or indirect participant relating to various phases, events and/or aspects associated with the user's life, including the user's birthday, anniversary, any other event or other social aspects associated with the user that can be scheduled as an event. The user may input these user-specific events or user-specific events may be determined from received financial events or other data.

In some embodiments, once the system receives the financial events data and user-specific events data, the system stores the data in a database and/or storage device associated with a mobile device.

As represented by the block 150, the system having the process flow 100 is also configured to present to the user, via the display of the mobile device, a calendar with one or more financial events provided therein, wherein each of the one or more financial events is selectable by the user.

In one embodiment, the system receives input from the user that the user desires to access the calendar, such as if the user selects a calendar application displayed on a graphical user interface of a mobile device. In some embodiments, the system receives input from the user that the user desires to access the calendar via an online banking account. In such instances, the user logs into the online banking account by providing a username and password for authentication and subsequently selecting or logging onto the calendar via the online banking account user interface.

In one embodiment, upon determining that the user has accessed the calendar, the system automatically populates the calendar with the one or more financial events and other user events. The calendar may be populated for only the current selected time span (e.g., current week, current month, etc.) or for all time spans available. A combination of the one or more financial events and user events populate the calendar.

In some embodiments, the calendar is presented in a browser, such as an internet browser or any browser on an operating system. In a further embodiment, the user links the calendar to one or more computer programs, including various electronic calendar programs. Other embodiments include presenting the calendar on a personal digital assistant (PDA), smartphone, computer, mobile telecommunication device, an alerting device (e.g., a pager), or other electronic device. For example, portions of the calendar, such as the one or more financial events or daily events of the user can be presented to the user via a calendar (or other software) on a user's PDA, laptop computer, tablet computer, or other electronic device. Further, the portions of the calendar can be presented to the user via a user's mobile device via an email message, text message, and Multimedia Messaging Service (MMS) text message, a telephone call to the user, a voice message, or any other method of presenting information to the user's electronic devices. The calendar can be presented to the user in a visual format, audibly, any combination thereof or by any other method. It should be understood that a variety of ways of presenting the calendar to the user are well within the scope of the invention, and the previously-mentioned examples and embodiments are not intended to limit the method of presentation of the calendar.

In one embodiment, the calendar is an online product such that the user enrolls into an online account and the calendar is generated and presented to the user by the online product. For example, the above described methods may be embodied in an online banking system where a user that has a financial account with a bank logs into the user's online account. Once the user logs into the user's account, the calendar (or a portion thereof) can be accessed by the user

In some embodiments, upon selecting one of the one or more financial events, the system is configured to enlarge the display of the financial event on the display of the mobile device so that the user can clearly identify details of the financial event. In such instances, the display is made large enough so that the user can identify the financial event and other information associated with the financial event. The other information associated with the financial event may include the name of a biller, the amount owed to the biller for services and/or goods, name of a loan provider, the type of financial documents to be reviewed and/or executed by the user, etc.

As represented by the block 160, the system having the process flow 100 is also configured to provide, via each of the one or more financial events, one or more selectable features configured to allow the user to take an action relating to the one or more financial events. In some embodiments, the one or more selectable features provided may be one or more selectable links, images, buttons, etc. useable by the user to take an action relating to the one or more financial events. Upon selecting the one or more selectable features provided, the user may be redirected to an online banking website, an online payment website, an online document retrieval website, or some other online interface that allows the user to access documents related to the financial event, access a payment system or platform for scheduling or making a payment, and/or any other action related to the financial events. In some embodiments, the one or more selectable features allows the user to set up a recurring or non-recurring payment to a biller associated with the financial event, delay a scheduled payment to the biller using various payment systems (e.g., online bill payment system, automatic payment systems, etc.), dispute a bill amount associated with the financial event, retrieve electronic documents and/or other information associated with the financial event, electronically execute and/or sign a document, review loan documents, review financial documents, confirm a scheduled payment to a merchant or biller associated with the financial event, access an online banking website for performing various financial transactions including funds transfers, access online bill payment system, review investments, execute one or more trades of equities (e.g., stocks, mutual funds, EFTs, etc.), open and/or close and/or suspend an account, etc. For example, in one embodiment, the financial event shown on the calendar is an upcoming bill. The user may select the financial event by touching or otherwise indicating that he/she would like to access the specific financial event. Selecting the financial event opens the event and displays to the user the details of the event that may include the biller, the billed amount, and due date for the billed amount. Once the financial event is opened, it may also display options to act on the bill by displaying one or more selectable features, such as a “Pay Now!” or a “Schedule Payment” button. If the user selects the Pay Now button, he/she may be redirected to an online banking website, where he/she is prompted to authenticate herself by entering a username and password. Using her online banking account the user may pay her bill now or alternatively schedule a future payment. The one or more selectable features may provide various actions to aid the user determine a disposition or otherwise take some action towards the financial event.

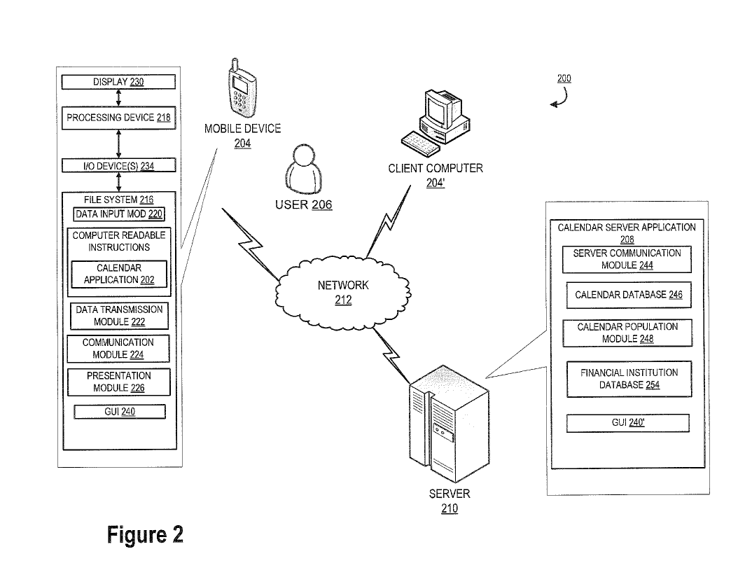

Referring now to FIG. 2, a block diagram of an example system 200 for providing a calendar for displaying one or more financial events is provided, in accordance with embodiments of the invention. The system 200 includes a calendar application 202 operable on a mobile device 204 or similar device of a user 206 or a client computer 204′. In addition to the calendar application 202 on the user's mobile device 204 or client computer 204′, the system 200 includes a calendar server application 208 operable on a server 210 and accessible by the user 206 or client computer 204′ via a network 212. The server 210 may be maintained by a financial institution associated with the user or some third party. The previously discussed process flow 100 are embodied or performed by the calendar application 202 or the calendar server application 208. For example, the process flow 100 may be performed by the calendar application 202. In another embodiment, the process flow 100 may be performed by the calendar server application 208. In a further embodiment of the invention, some of the features or functions of the process flow 100 are performed by the calendar application 202 on the user's mobile device 204 and other features or functions of the process flow 100 are performed on the calendar server application 208.

The network 212 is the Internet, a private network or other network. Each client computer 204′ is similar to the exemplary mobile device 204 and associated components as illustrated in FIG. 2.

The calendar application 202 and/or calendar server application 208 is a self-contained system with imbedded logic, decision making, state based operations and other functions that operate a calendar product.

The calendar application 202 is stored on a file system 216 or memory of a mobile device 204. The calendar application 202 may be accessed from the file system 216 and run on a processor 218 associated with the mobile device 204.

The calendar application 202 includes a data input module 220. The data input module 220 allows for entry of user information such as enrollment information, preferences, and updates. The data input module 220 is accessed or activated whenever the user 206 indicates a desire to activate the calendar program and calls other modules such as the graphical user interface 240, as described below. The calendar application 202 also includes data transmission module 222. At this point, the input of user information from the mobile device 204 is transmitted to the calendar application 208 on the server 210 via the network 212. The input of user information can include information associated with one or more financial events, enrollment information, user-inputted data regarding preferences, and the like inputted from the data input module 220 or information obtained via a different module.

The calendar application 202 also includes a communication module 224. The communication module 224 allows a user to receive information from the calendar server application 208 on the server 210. This information can include financial events data, online bill payment system data, user data, user events, and/or other information related to the functioning of the calendar. The communication module 224 allows a user to transmit back to the server 210 a response to a message, alert, and/or prompts to user for taking action on one or more financial events. The user is able to indicate a desire to take an action on one or more financial events or perform other functions which require communications between the mobile device 204 and the server 210.

The calendar application 202 further includes a presentation module 226. The presentation module 226 presents the calendar to the user so that the user may see any financial events, user data, user events, and/or other information that have been populated in the calendar. The presentation module 226 displays the calendar in a smart phone, a browser, other software product via a PDA, other computing device, or other similar electronic media.

The user's mobile device 204 includes a display 230. Any graphical user interfaces 240 associated with the calendar server application 208 is presented on the display 230. The user's mobile device 204 also includes one or more input devices, output devices or combination input and output devices, collectively I/O devices 234. The I/O device 234 includes a keyboard, computer pointing device, touch screen, touch pad, or similar devices to control input of information as described herein. The I/O devices 234 also include disk drives or devices for reading computer media including computer readable or computer operable instructions.

The calendar application 202 presents the current status and other desired information of the calendar product to the user 206, such as by presenting the current status information to a display 230, storing results in the file system 216, etc.

The calendar server application 208 additionally includes a server communication module 244. The server communication module 244 performs operations similar to the communication module 224 on the user's mobile device 204, as previously discussed. However, the server communication module 244 performs the operations on the server 210 and communicates with other modules on the server 210, such as the enrollment module 250 for enrolling into an information feed from a financial institution.

The calendar server application 208 also includes a calendar database 246. The calendar database 246 includes any stored information related to user financial events, enrollment information, user preferences, user data, and any other information associated with the user in regards to the calendar.

The calendar server application 208 further includes a calendar population module 248. The calendar population module 248 is called when the user 206 indicates a desire to view and/or update the calendar. The calendar population module 248 calls other modules on the server 210, such as the calendar database 246, to populate the calendar according to the user's preferences with user's financial events, user data, other events, and other information, and then to display the calendar data so that the user may view the calendar data on the computer system display 230.

The calendar server application 208 yet further includes a financial institution database 254. The financial institution database 254 includes any stored information owned by and related to financial institution users, such as user's transaction information, financial events information, and the like.

The calendar application 202, 208 includes graphical user interfaces 240, 240′, as previously mentioned. The calendar application 202 and/or calendar server application 208 allows one or more predetermined graphical user interfaces 240 to be presented to the user 206 in order for the user 206 to input data or information into the system 200. The graphical user interfaces 240 are predetermined and/or presented in response to the user 206 indicating the user 206 would like to perform a task associated with the calendar, such as taking action on a financial event, inputting user data and events, etc. The predetermined graphical user interfaces 240 are generated by the calendar application 202 and/or calendar server application 208 and are presented on the display 230 at the mobile device 204. Graphical user interfaces 240 also include graphical user interfaces that permit the user 206 to view the calendar and query any of the databases and/or generate reports and/or respond to prompts.

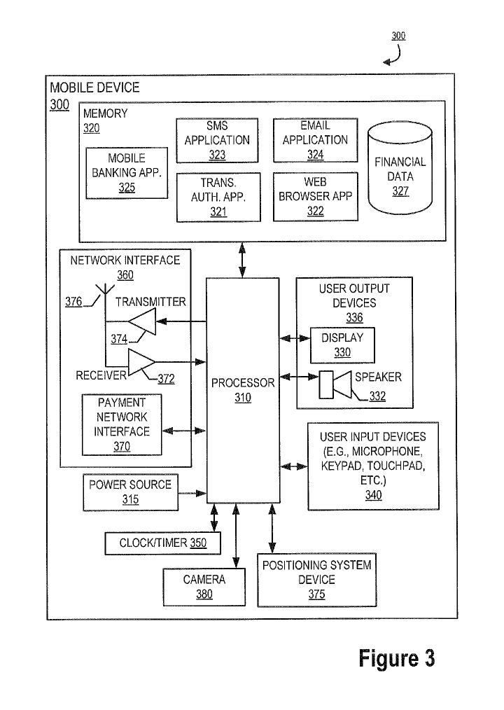

Referring now to FIG. 3, the mobile device 300 associated with the user is described more specific detail. FIG. 3 provides a block diagram illustrating a mobile device 300 in accordance with embodiments of the invention. In one embodiment of the invention, the mobile device 300 is a mobile telephone. However, it should be understood that a mobile telephone is merely illustrative of one type of mobile device 300 that may benefit from, employ, or otherwise be involved with embodiments of the invention and, therefore, should not be taken to limit the scope of embodiments of the invention. Other types of mobile devices 300 may include portable digital assistants (PDAs), tablets, pagers, mobile televisions, gaming devices, laptop computers, cameras, video recorders, audio/video player, radio, GPS devices, or any combination of the aforementioned.

The mobile device 300 generally includes a processor 310 communicably coupled to such devices as a memory 320, user output devices 336, user input devices 340, a network interface 360, a power source 315, a clock or other timer 350, a camera 380, and a positioning system device 375. The processor 310, and other processors described herein, generally includes circuitry for implementing communication and/or logic functions of the mobile device 300. For example, the processor 310 may include a digital signal processor device, a microprocessor device, and various analog to digital converters, digital to analog converters, and/or other support circuits. Control and signal processing functions of the mobile device 300 are allocated between these devices according to their respective capabilities. The processor 310 thus may also include the functionality to encode and interleave messages and data prior to modulation and transmission. The processor 310 can additionally include an internal data modem. Further, the processor 310 may include functionality to operate one or more software programs, which may be stored in the memory 320. For example, the processor 310 may be capable of operating a connectivity program, such as a web browser application 322. The web browser application 322 may then allow the mobile device 300 to transmit and receive web content, such as, for example, location-based content and/or other web page content, according to a Wireless Application Protocol (WAP), Hypertext Transfer Protocol (HTTP), and/or the like.

The processor 310 is configured to use the network interface 360 to communicate with one or more other devices on the network 350. In this regard, the network interface 360 includes an antenna 376 operatively coupled to a transmitter 374 and a receiver 372 (together a “transceiver”). The processor 310 is configured to provide signals to and receive signals from the transmitter 374 and receiver 372, respectively. In some embodiments where network 350 is a wireless telephone network, the signals may include signaling information in accordance with the air interface standard of the applicable cellular system of the wireless telephone network. In this regard, the mobile device 300 may be configured to operate with one or more air interface standards, communication protocols, modulation types, and access types. By way of illustration, the mobile device 300 may be configured to operate in accordance with any of a number of first, second, third, and/or fourth-generation communication protocols and/or the like. For example, the mobile device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 300 may also be configured to operate in accordance with non-cellular communication mechanisms, such as via a wireless local area network (WLAN), near field communication network, or other communication/data networks.

The network interface 360 may also include a payment network interface 370. The payment network interface 370 may include software, such as encryption software, and hardware, such as a modem, for communicating information to and/or from one or more devices on a network 350. For example, the mobile device 300 may be configured so that it can be used as a credit or debit card by, for example, wirelessly communicating account numbers or other verification information to point of transaction computer system.

As described above, the mobile device 300 has a user interface that is, like other user interfaces described herein, made up of user output devices 336 and/or user input devices 340. The user output devices 336 include a display 330 (e.g., a liquid crystal display or the like) and a speaker 332 or other audio device, which are operatively coupled to the processor 310. The user input devices 340, which allow the mobile device 300 to receive data from user, may include any of a number of devices allowing the mobile device 300 to receive data from a user, such as a keypad, keyboard, touch-screen, touchpad, microphone, mouse, joystick, other pointer device, button, soft key, and/or other input device(s). The user interface may also include a camera 380, such as a digital camera.

The mobile device 300 may also include a positioning system device 375 that is configured to be used by a positioning system to determine a location of the mobile device 300. For example, the positioning system device 375 may include a GPS transceiver. In some embodiments, the positioning system device 375 is at least partially made up of the antenna 376, transmitter 374, and receiver 372 described above. For example, in one embodiment, triangulation of cellular signals may be used to identify the approximate location of the mobile device 300. In other embodiments, the positioning system device 375 includes a proximity sensor or transmitter, such as an RFID tag, that can sense or be sensed by devices known to be located proximate a merchant or other location to determine that the consumer mobile device 300 is located proximate these known devices.

The mobile device 300 further includes a power source 315, such as a battery, for powering various circuits and other devices that are used to operate the mobile device 300. Embodiments of the mobile device 300 may also include a clock or other timer configured to determine and, in some cases, communicate actual or relative time to the processor 310 or one or more other devices.

The mobile device 300 also includes a memory 320 operatively coupled to the processor 310. As used herein, memory includes any computer readable medium (as defined herein below) configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory can additionally or alternatively include an electrically erasable programmable read-only memory (EEPROM), flash memory or the like.

The memory 320 can store any of a number of applications which comprise computer-executable instructions/code executed by the processor 310 to implement the functions of the mobile device 300 described herein. For example, the memory 320 may include such applications as a transaction verification application 321, conventional web browser application 322, a SMS application 323, and email application 324 and/or mobile banking application 325. These applications also typically provide a graphical user interface (GUI) on the display 330 that allows user to communicate with a point of transaction computer system and/or financial institution computer system. In some embodiments, memory 320 may store financial data 327. Financial data 327 may comprise data or information relating to transactions of a user, such as credit card information, debit card information, bank account information, and/or information necessary to validate transactions involving the user. In some embodiments, financial data 327 may include the stored information that is used to determine offers for products during a user shopping experience.

The memory 320 can also store any of a number of pieces of information, and data, used by the mobile device 300 and the applications and devices that make up the mobile device 300 or are in communication with the mobile device 300 to implement the functions of the mobile device 300 and/or the other systems described herein.

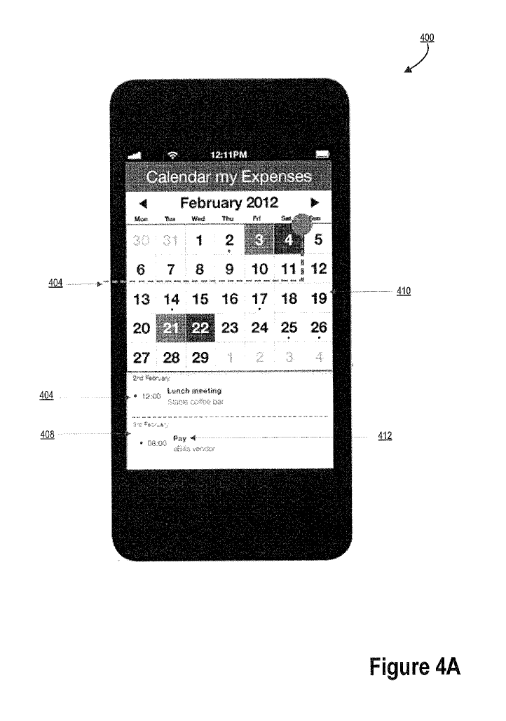

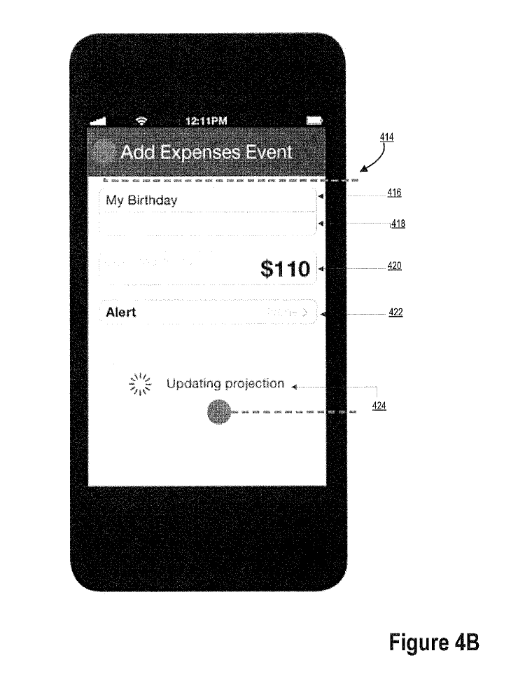

FIG. 4A is an exemplary embodiment of a graphical user interface for a calendar for bill payment management in accordance with some embodiments of the invention. The calendar 400 is illustrated as being displayed via a mobile device 300. The calendar 400 presents user social events 404, user financial events 406, and/or other information. The, user social events 404, user financial events 406, and other information for the calendar 400 of FIG. 4A was developed in accordance with the process flow 100 and systems 200 and 300 as described above.

The upcoming bills 408 of the user appear as financial events 406 on the calendar 400. By selecting a calendar date 410 or opening the event on the calendar 400, the upcoming bill 408 and/or social event 404 associated with the calendar date 410 is presented to the user via the calendar 400. The calendar 400 will further display options 412 to act on the bill proximate to the upcoming bill 408. For example, the calendar 400 will display a “Pay” option 412 next to the upcoming bill 408 that the user can select or open which would allow the user to pay the upcoming bill 408.

FIG. 4B is an exemplary embodiment of a graphical user interface 414 for adding financial events 406 and/or upcoming bills 408 to a calendar 400. The graphical user interface 414 is illustrated as being displayed via a mobile device 300. The graphical user interface 414 presents an input screen that allows the user to add a description 416 of an expected financial event or expense, add a date 418 for the financial event, add the amount 420 for the expected expense for the financial event 406, and add an alert 422 for the financial event 406. The calendar 400 will further display an update to a money flow outlook 424 associated with the user either contemporaneously or immediately after the user enters the expected expense amount 420 for the financial event 406. The graphical user interface 414 as illustrated in FIG. 4A was developed in accordance with the process flow 100 and systems 200 and 300.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

This application incorporates by reference in their entirety each of the following applications filed concurrently herewith:
U.S. application Ser. No. ______, entitled BILL CONTROL, filed Jul. 6, 2012 to Carrie Hanson et al. (Atty. Dkt. 5163US1.014033.1650);
U.S. application Ser. No. ______, entitled ELECTRONIC PROCESSING OF PAPER INVOICES, filed Jul. 6, 2012 to Carrie Hanson et al. (Atty. Dkt. 5168US1.014033.1660);
U.S. application Ser. No. ______, entitled FINANCIAL DOCUMENT PROCESSING SYSTEM, filed Jul. 6, 2012 to Carrie Hanson et al. (Atty. Dkt. 5169US1.014033.1661);
U.S. application Ser. No. ______, entitled TRANSACTION MONITORING AND SAVINGS FEATURE, filed Jul. 6, 2012 to Carrie Hanson et al. (Atty. Dkt. 5172US1.014033.1663);
U.S. application Ser. No. ______, entitled BILL PAYMENT MANAGEMENT, filed Jul. 6, 2012 to Carrie Hanson et al. (Atty. Dkt. 5173US1.014033.1662);
U.S. application Ser. No. ______, entitled EARNING REWARDS VIA BILL PAYMENT, filed Jul. 6, 2012 to Carrie Hanson et al. (Atty. Dkt. 5174US1.014033.1649); and
U.S. application Ser. No. ______, entitled FUTURE ACCOUNT VIEW, filed Jul. 6, 2012 to Carrie Hanson et al. (Atty. Dkt. 5175US1.014033.1651);

1. A system for providing a calendar for displaying and taking action on financial events, the system comprising:
a mobile device of a user, the mobile device comprising a communication interface, a processing device, and a display, wherein the mobile device is configured to present, via the display of the mobile device, a personal calendar comprising a) a plurality of financial events relating to one or more future inflows of funds into and to one or more future outflows of funds out of one or more fund accounts of the user and b) information associated with one or more future social events associated with the user;
a storage device of the mobile device, the storage device comprising information associated with the personal calendar;
a non-transitory computer-readable medium comprising computer-executable instruction code, that when executed causes the processing device to:
access the storage device of the mobile device to retrieve information associated with the personal calendar; and
present, via the display of the mobile device:
a) the personal calendar comprising the plurality of financial events relating to the one or more future inflows of funds into and to the one or more future outflows of funds out of the one or more fund accounts of the user and the one or more future social events associated with the user, and
b) one or more user-selectable input features within the personal calendar for each of the plurality of financial events, wherein each of the one or more user-selectable input features, when selected by the user, is configured to present one or more options for taking an action relating to the one or more future inflows of funds into and to one or more future outflows of funds out of the one or more fund accounts of the user.

2. The system of claim 1, wherein the one or more financial events are one or more recurring or non-recurring upcoming bills, expenses, payments, liabilities, allowances, paychecks, closings, or financial transactions associated with the user.

3. The system of claim 1, wherein the non-transitory computer-readable medium comprising computer-executable instruction, that when executed further causes the processing device to:
receive, from the user, via the calendar a selection of the one or more user-selectable input features; and
redirect the user to an online banking website based at least partially on receiving the selection.

4. The system of claim 1, wherein the non-transitory computer-readable medium comprising computer-executable instruction, that when executed further causes the processing device to:
receive, via the calendar, one or more manual inputs of one or more financial events associated with the user, wherein the one or more manual inputs of the one or more projected financial events relate at least partially to one or more upcoming expenses or one or more upcoming bills.

5. The system of claim 4, wherein the non-transitory computer-readable medium comprising computer-executable instruction, that when executed further causes the processing device to:
trigger an update of a projected money flow outlook for the user based at least partially on receiving the one or more manual inputs of one or more projected financial events, wherein the projected money flow outlook is an illustration of an estimation of future money flow totals of the one or more financial events associated with the calendar of the user;
update the projected money flow outlook based at least partially on the one or more manual inputs; and
present, via the calendar, the projected money flow outlook updated with the one or more manual inputs of the one or more projected financial events.

6. The system of claim 1, wherein the non-transitory computer-readable medium comprising computer-executable instruction, that when executed further causes the processing device to:
provide a user interface configured to receive an indication that the user would like to receive, at the mobile device, a feed of one or more financial events
receive the indication from the user; and
provide the feed of one or more financial events.

7. The system of claim 1, wherein the non-transitory computer-readable medium comprising computer-executable instruction, that when executed further causes the processing device to:
present, via the mobile device, a user-authentication screen to the user for accessing the contents of the calendar, wherein the user-authentication screen is configured to receive one or more inputs from the user.

8. The system of claim 1, wherein the non-transitory computer-readable medium comprising computer-executable instruction, that when executed further causes the processing device to:
receive one or more updates relate at least partially to one or more financial events associated with an online bill payment system, wherein the updates are provided from a financial institution.

9. A computer program product for providing a calendar for displaying and taking action on financial events, the computer program product comprising:
a non-transitory computer readable medium comprising a set of codes for causing a computer to:
access a storage device associated with a mobile device to thereby retrieve information associated with a calendar and information associated with a plurality of financial events to be displayed within the calendar, wherein the information associated with the calendar comprises one or more social events associated with an individual user;
present, via a display of a mobile device:
a) the calendar comprising the plurality of financial events relating to one or more future inflows of funds into and to one or more future outflows of funds out of the one or more fund accounts of the individual user, the and
b) one or more user-selectable input features within the calendar for each of the plurality of financial events, wherein each of the one or more user-selectable input features, when selected by the user, is configured to present one or more options for taking an action relating to the one or more future inflows of funds into and to one or more future outflows of funds out of the one or more fund accounts of the individual user.

10. The computer program product of claim 9, further comprising a set of codes for causing the computer to:
receive, from the user, via the calendar a selection of the one or more user-selectable input features; and
redirect the user to an online banking website based at least partially one receiving the selection.

11. The computer program product of claim 9, further comprising a set of codes for causing the computer to:
receive, via the calendar, one or more manual inputs of one or more financial events associated with the user, wherein the one or more manual inputs of the one or more financial events relate at least partially to one or more upcoming expenses or one or more upcoming bills.

12. The computer program product of claim 11, further comprising a set of codes for causing the computer to:
trigger an update of a projected money flow outlook for the user based at least partially on receiving the one or more manual inputs of one or more projected financial events;
update the projected money flow outlook based at least partially on the one or more manual inputs; and
present, via the calendar, the projected money flow outlook updated with the one or more manual inputs of the one or more projected financial events;

13. The computer program product claim 9, further comprising a set of codes for causing the computer to:
present, via the mobile device, a user-authentication screen to the user for accessing the contents of the calendar, wherein the user-authentication screen is configured to receive one or more inputs from the user.

14. A computer-implemented method for providing a personal calendar for displaying and taking action on one or more financial events, the computer-implemented method comprising:
providing a processing device executing computer readable code structured to cause the computer processor to:
access, via a storage device associated with a mobile device of a user, information associated with a personal calendar of the user, the information associated with the personal calendar comprising a plurality of financial events relating to one or more inflows of money into and one or more outflows out of one or more financial accounts of the user;
present, via a display of the mobile device:
a) the personal calendar comprising the plurality of financial events relating to the one or more inflows of money into and the one or more outflows of money out of the one or more financial accounts of the user, wherein each of the plurality of financial events is presented within the personal calendar; and
b) one or more user-selectable input features within the personal calendar for each of the plurality of financial events, wherein the user-selectable input features, when selected by the user, is configured to present one or more options for taking an action relating to the one or more inflows of money into and relating to the one or more outflows of money out of one or more financial accounts of the user.

15. The computer-implemented method of claim 14, further comprising computer-executable instruction code, that when executed causes the processing device to:
receive, from the user, via the mobile device a selection of the one or more user-selectable input features; and
redirect the user to an online banking website based at least partially on receiving the selection.

16. The computer-implemented method of claim 14, further comprising computer-executable instruction code, that when executed causes the processing device to:
receive, via the calendar, one or more manual inputs of one or more financial events associated with the user, wherein the one or more manual inputs of one or more financial events relate at least partially to one or more upcoming expenses or one or more upcoming bills;

17. The computer-implemented method of claim 16, further comprising computer-executable instruction code, that when executed causes the processing device to:
trigger an update of a projected money flow outlook for the user based at least partially on receiving the one or more manual inputs of the one or more projected financial events;
update the projected money flow outlook based at least partially on the one or more manual inputs; and
present, via the calendar, the projected money flow outlook updated with the one or more manual inputs of the one or more financial events.

18. The computer-implemented method of claim 14, further comprising computer-executable instruction code, that when executed causes the processing device to:
present, via the mobile device, a user-authentication screen to the user for accessing the contents of the calendar, wherein the user-authentication screen is configured to receive one or more inputs from the user.

19. The computer-implemented method of claim 14, further comprising computer-executable instruction code, that when executed causes the processing device to:
provide a user interface configured to receive an indication that the user would like to receive, at the mobile device, a feed of one or more financial events from a server associated with a financial institution associated with the user; and
receive the indication from the user.

20. The computer-implemented method of claim 14, wherein the calendar is a combination of, at least two calendars, the calendar comprising a first calendar associated with the mobile device associated with the user and a second calendar accessible via an online banking account associated with the user, wherein the first calendar comprises one or more non-financial related events, and wherein the second calendar comprises one or more financial related events.
